(19) United States
(12) Patent Application Publication
(10) Pub. No.: US 2010/0156044 A1
(43) Pub. Date: Jun. 24, 2010

(54) Rapid fixing lock structure of balance board

(75) Inventor: Kwok Kee Chong, Hong Kong (HK)

Correspondence Address: Ben Kwong;General Commercial Building, Rm404, 4/F., 162 Des Voeux Road, Central, Hong Kong, HK

(73) Assignee: Qualtech Global Ltd., Hong Kong (HK)

(21) Appl. No.: 12/337,653

(22) Filed: Dec. 18, 2008

(51) Int. Cl. A63F 13/02; A63F 9/00

(52) U.S. Cl. 273/148 B; 273/450

(57) ABSTRACT

The present utility model provides a rapid fixing lock structure of a balance board, relating to a connecting part of balance board and its fittings for game players. The rapid fixing lock structure of the balance board can fix different balance board fittings to a balance board according to various games so as to increase the sense of reality and fun from balance board game. The rapid fixing lock structure of the balance board comprises: a base, a rapid snap close and a rotating shaft; the base consists of a rotating shaft fixing structure, on which the rotating shaft is mounted; the rapid snap close is L shape formed by two vertical sides perpendicular to each other, wherein the end of the first vertical side is provided with a sprocket for buckling the balance board slot on the balance board, the end of the second vertical side is equipped with a rotating shaft hole of the rapid snap close; the rapid snap close connects the base through the rotation of the rotating shaft. Compared with existing technology, the present utility model enables the player to have a more vivid experience from game, thus to increase the sense of reality and fun from the balance board game.

### FIELD OF THE TECHNOLOGY

The present utility model relates to player hardware, in particular, to a connecting structure of balance board and its fittings for player.

### BACKGROUND OF THE TECHNOLOGY

Nintendo (Wii) games are very popular video games currently. During the development of Wii games, commonly seen hardware is mainly composed of the main unit, display and controller, wherein the main unit is configured with game operating system and software, the display can be a household TV and the prevalent controller at present mainly includes Wii—Remote standard controller and Wii—Nunchuk shuttle controller. The communication between the controller and main unit are transferred by Bluetooth. The main unit connects the display. The player performs the game activity displayed on display through operating the controller.

Among the fittings on Nintendo games, there is a fitting called a balance board. The balance board can detect the pressure generated by the player, then the weight, balance state, etc. data can be obtained, communicating with the Wii main unit in wireless mode. Through the balance board and the corresponding software installed on the main unit, the player can conduct various fitness exercises, such as push-up, aerobics, hula hoop, ball playing and skateboard, etc. poses to simulate body-building activities, and then the system will detect the player's exercise effect and physical status according to the player personnel' actions.

Since the Nintendo balance board is of an unchanging shape, the player's movement range is limited by the size of the balance board, while different balance board games require diversified movement range, such as the skateboard game which requires a larger area of balance board than treadle area; therefore, the player finds it less realistic sense to play the skateboard game of the balance board.

### Summary of the Utility Model

The technical problem for the present utility model is to provide a rapid fixing lock structure of the balance board, wherein the balance board can fix different balance board fittings on balance board according to different games, in this way, to increase the sense of reality and fun from balance board games.

To address the abovementioned technical problems, the present utility model puts forward a rapid fixing lock structure of balance board, wherein the rapid fixing lock structure of balance board comprises:

A base, a rapid snap close and a rotating shaft;

Wherein, the base consists of a rotating shaft fixing structure, on the rotating shaft fixing structure of the base the rotating shaft is mounted;

The rapid snap close is an L shape formed by two vertical sides perpendicular to each other, wherein the end of the first vertical side is provided with a sprocket for buckling the balance board slot on the balance board, the end of the second vertical side is equipped with a rotating shaft hole of the rapid snap close;

The rapid snap close connects the base through the rotation of the rotating shaft.

Preferably, the rotating shaft fixing structure comprises a shaft base which further includes a shaft base plate and shaft base post, wherein one end of the latter is connected on the plate surface of the shaft base plate, the other end of the post is provided with a shaft hole; a base hole is set in the base for fastening the shaft base, wherein the base hole covers a smaller area than that of the base plate; the shaft base post passes through the base hole, extends out from the shaft hole of the base and further connects the rotating shaft outside the base.

Preferably, the base comprises: a transversal rotating angle limit plate used to limit the lower position of the rotating angle of the rapid snap close, an upright shaft base fixing plate connecting the rotating angle limit plate; the base hole is set in the shaft base fixing plate.

Preferably, a certain down-slope face is formed at the connecting position of the rotating angle limit plate and the shaft base fixing plate with inclination downwards.

The favorable effects of the present utility model include:

Comparing with the existing technology, the present utility model utilizes the slot and hole structure feature in the Wii balance board and makes it as the buckling slot connecting other fittings, and then the technical solution for the present utility model is designed. The utilization of the rapid fixing lock structure of balance board for the present utility model enables the balance board to connect various game fittings of balance board properly, the buckle is designed to just place the corresponding position on the Wii balance board and can make balance board to be rapidly and tightly buckled on different fittings, in this way, the player can have a more vivid experience from the game, thus to increase the sense of reality and fun from the balance board game.

### DESCRIPTION OF THE DRAWINGS

FIG. 1 is the structure view of Embodiment 1, wherein the rapid snap close is in the unlocking state.

FIG. 2 is the structure view of rapid snap close mentioned in the Embodiment of FIG. 1 but in buckling state.

FIG. 3 is the exploded structure view of the Embodiment in FIG. 1.

FIG. 4 is the section view of FIG. 2 along A-A direction.

### DETAILED DESCRIPTION OF THE EMBODIMENTS

The present utility model provides a rapid fixing lock structure of balance board.

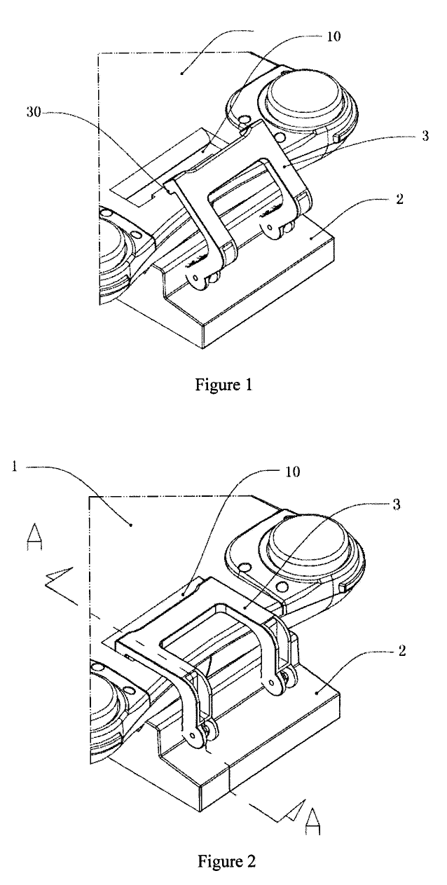

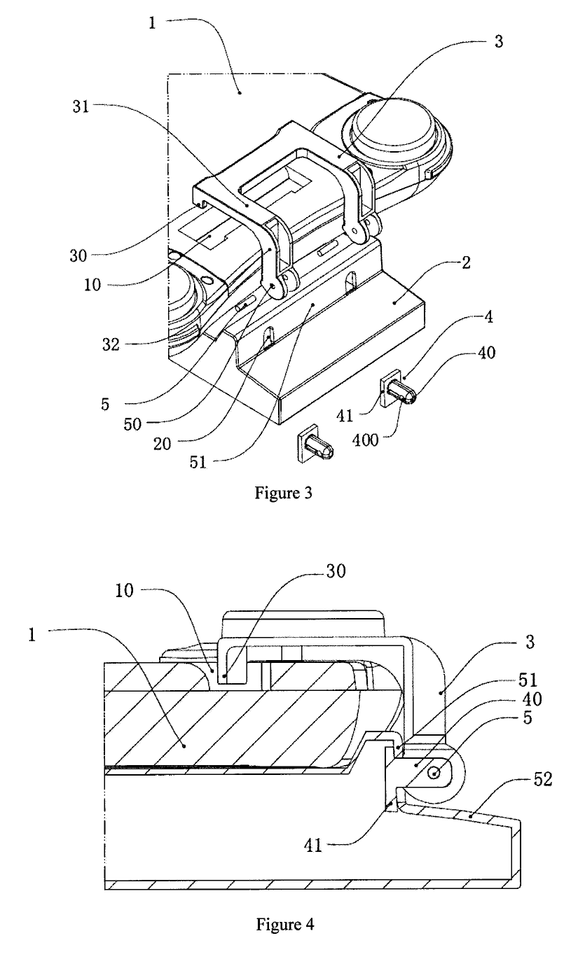

Refer to FIGS. 1˜4 for the structure of the embodiment. Take the Wii skateboard game as an example, namely, a fitting in the same size with the skateboard is configured on the balance board 1, thus the player personnel on the skateboard can have a more vivid experience for the fun of skateboard game.

The rapid fixing lock structure of balance board is mainly composed of three parts: a base 2, a rapid snap close 3 and a rotating shaft 5, wherein the base 2 is s part of the skateboard bottom.

The base 2 consists of a rotating shaft fixing structure, on which (on the base 2) the rotating shaft 5 is mounted. The rotating shaft fixing structure comprises a shaft base 4 which 4 further includes a shaft base board 41 and a shaft base post 40, wherein one end of the latter 40 is connected on the plate surface of the shaft base plate 41, the other end of the post 40 is provided with a shaft hole 400. The rotating shaft fixing structure further comprises a transversal rotating angle limit plate 52 used to limit the lower position of the rotating angle of the rapid snap close 3, an upright shaft base fixing plate 51 connecting the rotating angle limit plate 52. A certain down-slope face is formed at the connecting position of the rotating angle limit plate 52 and the shaft base fixing plate 51 with a downwards inclination, thus the rapid snap close 3 has a larger rotating angle. A base hole 20 is set in the shaft base fixing plate 51 of the base 2, wherein the base hole 20 covers a smaller area than that of the base board 41. The shaft base post 40 passes through the base hole 20, extends out from the shaft hole 400 of the base 2 and further connects the rotating shaft 5 outside the base 2.

The rapid snap close 3 is an L shape formed by two vertical sides perpendicular to each other, wherein the end of the first vertical side 31 is provided with a sprocket 30 for buckling the balance board slot 10 on the balance board, the end of the second vertical side 32 is equipped with a rotating shaft hole of the rapid snap close 50.

The rapid snap close 3 connects the base 2 through the rotation of the rotating shaft 5.

When utilized, the rapid snap close 3 shall be buckled into the balance board slot 10, then the fixed connection of skateboard on the base and the balance board 5 can be realized rapidly, in this achieve the skateboard game playing on the treadle surface in the same size with the simulation skateboard on the balance board. In addition to the skateboard, the fittings for the balance board can also be other bodybuilding games requiring a larger area of the treadle, such as gymnastics, etc.

1. A rapid fixing lock structure of balance board, characterized in that the rapid fixing lock structure of balance board comprises: A base (2); a rapid snap close (3) and a rotating shaft (5); Wherein: the base (2) consists of a rotating shaft fixing structure, on which (on the base (2)) the rotating shaft (5) is mounted; the rapid snap close (3) is an L shape formed by two vertical sides perpendicular to each other, wherein the end of the first vertical side (31) is provided with a sprocket (30) for buckling the balance board slot (10) on the balance board, the end of the second vertical side (32) is equipped with a rotating shaft hole of the rapid snap close (50); Rapid snap close (3) connects the base (2) through the rotation of the rotating shaft (5).

2. The rapid fixing lock structure of balance board as claimed in claim 1, characterized in that the rotating shaft fixing structure comprises a shaft base (4) which (4) further includes a shaft base plate (41) and a shaft base post (40), wherein one end of the latter (40) is connected on the plate surface of the shaft base plate (41), the other end of the post (40) is provided with a shaft hole (400); a base hole (20) is set in the base (2) for fastening the shaft base (4), wherein the base hole (20) covers a smaller area than that of the base plate (41); the shaft base post (40) passes through the base hole (20), extends out from the shaft hole (400) of the base (2) and further connects the rotating shaft (5) outside the base (2).

3. The rapid fixing lock structure of balance board as claimed in claim 2, characterized in that the base (2) comprises: a transversal rotating angle limit plate (52) used to limit the lower position of the rotating angle of the rapid snap close (3), an upright shaft base fixing plate (51) connecting the rotating angle limit plate (52); the base hole (20) is set in the shaft base fixing plate (51).

4. The rapid fixing lock structure of balance board as claimed in claim 3, characterized in that certain down-slope face is formed at the connecting position of the rotating angle limit plate (52) and the shaft base fixing plate (51) inclines downwards.
